(19) United States
(12) Patent Application Publication
(10) Pub. No.: US 2024/0188032 A1
(43) Pub. Date: Jun. 6, 2024

(54) Timing And Frequency Compensation In Non-Terrestrial Network Communications

(71) Applicant: MediaTek Singapore Pte. Ltd., Singapore (SG)

(72) Inventors: Abdelkader Medles, Cambridge (GB); Gilles Charbit, Cambridge (GB)

(21) Appl. No.: 18/284,844

(22) PCT Filed: May 6, 2022
(86) PCT No.: PCT/CN2022/091144

§ 371 Date: Sep. 28, 2023

Related U.S. Application Data
(60) Provisional application No. 63/185,388, filed on May 7, 2021.

(51) Int. Cl. H04W 64/00; H04W 56/00; H04W 84/06

(52) U.S. Cl. CPC H04W 64/006; H04W 56/0045; H04W 84/06

(57) ABSTRACT

Various solutions for timing and frequency compensation in non-terrestrial network (NTN) communications are proposed. An apparatus implemented in a user equipment (UE) obtains a carrier frequency of an NTN. The apparatus generates an up-conversion signal by upconverting a baseband signal according to the carrier frequency. Then, the apparatus further obtains a pre-compensation frequency value. The apparatus performs an uplink (UL) frequency pre-compensation through adjusting a phase of the up-conversion signal according to the pre-compensation frequency value.

### CROSS REFERENCE TO RELATED PATENT APPLICATION(S)

The present disclosure is part of U.S. National Stage filing of International Patent Application No. PCT/CN2022/091144, filed 6 May 2022, which is part of a non-provisional application claiming the priority benefit of U.S. Provisional Patent Application No. 63/185,388, filed 7 May 2021, the content of which being incorporated by reference in its entirety.

### TECHNICAL FIELD

The present disclosure is generally related to mobile communications and, more particularly, to timing and frequency compensation in non-terrestrial network (NTN) communications.

### BACKGROUND

Unless otherwise indicated herein, approaches described in this section are not prior art to the claims listed below and are not admitted as prior art by inclusion in this section.

In NTN communications, in order to compensate for propagation delay and Doppler shift in wireless communications over a link, a user equipment (UE) needs to be aware of certain information. For example, the UE needs to know its UE position (e.g., via Global Navigation Satellite System (GNSS) positioning or a known position), the position and velocity of a satellite (or other flying object(s)) functioning as part of the NTN communications, and a time reference with respect to the position and velocity of the satellite. In case the satellite is a reference point, there would be no need for the UE to obtain information on a feeder link between a land-based network node (e.g., base station) and the satellite. In case the propagation delay includes the feeder link, the UE would need to know either the position of the land-based network node or information related to the feeder link (e.g., feeder link delay and delay drift rate). In case there is switching delay due to processing at the satellite, the UE would also need to know the switching delay.

The satellite links may have some impacts on signals transmitted by the UE. For example, Doppler shift on the service link, feeder link delay, service link delay, feeder link delay drift rate, and service link delay drift rate. Assuming the Doppler shift on the feeder link is perfectly compensated, the Doppler shift on the service link is a result of the service delay drift impact to the carrier frequency.

In addition, the UE uses the DL timing as a reference time, however, the DL timing has a delay itself, and the DL timing is a sum of a reference time, the service link delay, and the feeder link delay. Thus, the reception of the UL at base station has to correspond to reference time, and the UL pre-compensation needs to ensure that the timing is well pre-compensated. Similarly, the frequency of the UL received at the satellite also has to match reference frequency.

In the signal generation (e.g. 3GPP specification TS38.211 section 5.4), modulation and up-conversion to the carrier frequency f₀ of the complexed-valued OFDM baseband signal for antenna port p, subcarrier spacing configuration μ, and OFDM symbol l in a subframe assumed to start at t=0 is given by Re{sₗ^{(p,μ)}(t)·e^{j2πf}^{₀}^{(t-t}^{_{start,l}}^{^{μ}}^{-N}^{_{CP,l}}^{^{μ}}^{T}^{_{c}}⁾} for all channels and signals except for PRACH. If UE simply replaces f₀ by the shift frequency f₀−f_{pre-comp} for compensating the frequency, the constant phase across OFDM symbols at the receiver side will be destroyed and demodulation performance will also be degraded. To avoid this impact, frequency pre-compensation has to be applied without destroying the constant phase across OFDM symbols.

Furthermore, delay drift on the NT link leads to signal distortion, to avoid this signal distortion, delay drift compensation need to be applied.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure are believed to address issues pertaining to timing compensation in NTN communications.

In one aspect, a method may involve an apparatus obtaining a carrier frequency of a non-terrestrial network (NTN). The method may also involve the apparatus generating an upconversion signal by upconverting a baseband signal according to the carrier frequency. The method may also involve the apparatus obtaining a pre-compensation frequency value. The method may also involve the apparatus performing an uplink (UL) frequency pre-compensation through adjusting a phase of the upconversion signal according to the pre-compensation frequency value.

In another aspect, a method may involve an apparatus obtaining a carrier frequency of a non-terrestrial network (NTN). The method may also involve the apparatus generating an upconversion signal by upconverting a baseband signal according to the carrier frequency. The method may also involve the apparatus obtaining a time compression factor of the NTN. The method may involve the apparatus performing a timing compensation through applying the time compression factor to the upconversion signal.

In another aspect, an apparatus may include a transceiver and a processor coupled to the transceiver. The transceiver may be configured to wirelessly communicate with a non-terrestrial network (NTN). The processor may be configured to obtain, via the transceiver, a carrier frequency of a NTN. The processor may also generate an upconversion signal by upconverting a baseband signal according to the carrier frequency. The processor may obtain a pre-compensation frequency value. The processor may also perform an UL frequency pre-compensation through adjusting a phase of the upconversion signal according to the pre-compensation frequency value.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIoT), non-terrestrial network (NTN) and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to timing compensation in NTN communications. According to the present disclosure, a number of possible solutions may be implemented separately or jointly. That is, although these possible solutions may be described below separately, two or more of these possible solutions may be implemented in one combination or another.

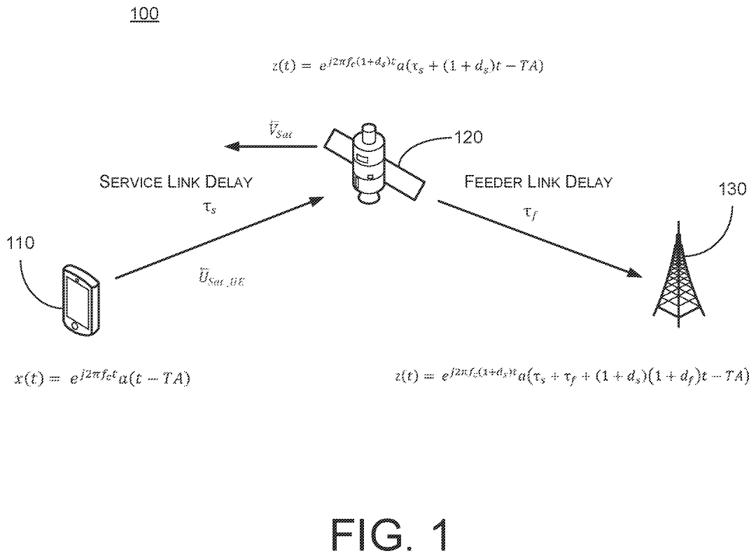

FIG. 1 illustrates an example network environment 100 in which various proposed schemes in accordance with the present disclosure may be implemented. Network environment 100 involves UE 110, non-terrestrial (NT) network node 120 (e.g., a satellite) and terrestrial network node 130 (e.g., a gateway, base station, eNB, gNB or transmission/reception point (TRP)), which may be a part of a wireless communication network (e.g., an LTE network, a 5G network, an NR network, an IoT network, an NB-IoT network, an IIoT network, an NTN network or a 6G network). UE 110 may be far from terrestrial network node 130 (e.g., not within the communication range of terrestrial network node 130) and not able to communicate with terrestrial network node 130 directly. Via NTN, UE 110 may be able to transmit/receive signals to/from NT network node 120. NT network node 120 may relay/transfer signals/data from UE 110 to terrestrial network node 130. Thus, terrestrial network node 130 may be able to communicate with UE 110 via NT network node 120. Since NT network node 120 is far from UE 110, propagation delay and Doppler frequency shift may be significant.

In non-terrestrial communication, satellite links (e.g., service link and feeder link) have impacts including Doppler frequency shift, feeder link delay τ_{f}, service link delay τₛ, feeder link delay drift d_{f} and service link delay drift dₛ on signals transmitted by the UE.

Furthermore, UE 110 always synchronizes to the downlink (DL) and uses the DL as a reference. However, the DL itself has a delay t_{DL}=t_{ABS}+τₛ+τ_{f}. The reception time of the UL at terrestrial network node 130 has to correspond to reference time t_{ABS}. Similarly, when transmitting uplink signals, UE 110 has to pre-compensate the Doppler frequency shift so that the frequency of the UL received at the NT network node 120 may match carrier frequency f₀.

However, in the signal generation (e.g. 3GPP specification TS38.211 section 5.4), modulation and up-conversion to the carrier frequency f₀ of the complexed-valued OFDM baseband signal for antenna port p, subcarrier spacing configuration μ, and OFDM symbol l in a subframe assumed to start at t=0 is given by Re{sₗ^{(p,μ)}(t)·e^{j2πf}^{₀}^{(t-t}^{_{start,l}}^{^{μ}}^{-N}^{_{CP,l}}^{^{μ}}^{T}^{_{c}}⁾} for all channels and signals except for PRACH. If UE 110 replaces f₀ by the shift frequency f₀−f_{pre-comp} for compensating the frequency, the constant phase across OFDM symbols at the receiver side will be destroyed and demodulation performance will also be degraded. To avoid this impact, frequency pre-compensation has to be applied without destroying the constant phase across OFDM symbols.

In view of the above, the present disclosure proposes a number of schemes pertaining to timing and frequency compensation/synchronization in NTN communications with respect to the UE 110, NT network node 120 and terrestrial network node 130. Under various proposed schemes in accordance with the present disclosure, each of the UE 110, the NT network node 120 and the terrestrial network node 130 may be configured to perform operations pertaining to carrier frequency, baseband signal, upconversion signal, and pre-compensation frequency value for uplink (UL) frequency pre-compensation in NTN communications, as described below.

Under a proposed scheme, UE 110 may obtain the carrier frequency of the NTN. Additionally, UE 110 may generate the upconversion signal by upconverting a baseband signal according to the carrier frequency. Also, UE 110 may obtain the pre-compensation frequency value.

In some implementations, the pre-compensation frequency value may be calculated by UE 110 using its position and potentially velocity and the ephemeris/trajectory information of the NT network node 120. Specifically, UE 110 may obtain a plurality of positions of the apparatus via a Global Navigation Satellite System (GNSS) and calculate its velocity according to the positions. UE 110 may further obtain a position of the NT network node 120 and a velocity of the NT network node 120. Then, UE 110 may calculate the pre-compensation frequency value according to one of the positions of UE 110, the velocity of UE 110, the position of the NT network node 120 and the velocity of the NT network node 120.

In some implementations, the pre-compensation frequency value is signalled by the terrestrial network node 130 using one of an open loop, a closed loop, and a combination thereof. In an event that UE 110 is not connected to the terrestrial network node 130 via the NT network node 120, the pre-compensation frequency value is signalled by the terrestrial network node 130 using the open loop (e.g., through broadcast information). In an event that UE 110 is connected to the terrestrial network node 130 via the NT network node 120, the pre-compensation frequency value is signalled by the terrestrial network node 130 using the closed loop or both of the open loop and the closed loop.

In some implementations, the pre-compensation frequency value corresponds to a Doppler frequency shift due to a movement of the NT network node 120. In some implementations, the pre-compensation frequency value corresponds to a Doppler frequency shift due to a movement of the UE 110. In some implementations, the pre-compensation frequency value corresponds to a Doppler frequency shift due to a movement of the NT network node 120 and a movement of the UE 110.

The Doppler frequency shift may be broadcast by the terrestrial network node 130 in a broadcast message (e.g., system information block (SIB)). In an event that the SIB is an existing SIB, the Doppler frequency shift may be added to an information element (IE) definition for the existing SIB. In an event that the SIB is a new SIB, a new IE may be defined for the new SIB that includes the Doppler frequency shift value. UE 110 may acquire the SIB with the Doppler frequency shift at various times.

Alternatively, the Doppler frequency shift may be provided to UE 110 within an RRCConnectionReconfiguration message or an RRCReconfiguration message. It is noteworthy that the option of using a dedicated RRC message to provide the Doppler frequency shift to UE 110 may be as alternative or in addition to providing the Doppler frequency shift in an SIB (e.g., by broadcast).

In some implementations, UE 110 may obtain a service link delay drift rate of a service link between UE 110 and NT network node 120. For instance, the service link delay drift rate may be signalled to UE 110 by the NT network node 120. Then, UE 110 may calculate the Doppler frequency shift as the carrier frequency times the service link delay drift rate.

UE 110 may perform UL frequency pre-compensation through adjusting a phase of the upconversion signal according to the pre-compensation frequency value. Also, UE 110 may further transmit an uplink signal by applying the pre-compensation frequency value. In detail, in 3GPP TS38.211 section 5.4, modulation and upconversion to the carrier frequency f₀ of the complexed-valued OFDM baseband signal for antenna port p, subcarrier spacing (SCS) configuration μ, and OFDM symbol l in a subframe assumed to start at t=0 is given by Re{sₗ^{(p,μ)}(t)·e^{j2πf}^{₀}^{(t-t}^{_{start,l}}^{^{μ}}^{-N}^{_{CP,l}}^{^{μ}}^{T}^{_{c}}⁾} for all channels and signals except physical random access channel (PRACH) and by Re{sₗ^{(p,μ)}·e^{j2πf}^{₀}^{t}} for PRACH. sₗ^{(p,μ)} (t) denotes the baseband signal which is time-continuous. f₀ denotes the carrier frequency. t_{start,l}^{μ} denotes the starting time of OFDM symbol l for subcarrier spacing configuration μ in a subframe. N_{CP,l}^{μ} denotes the cyclic prefix length N_{cp} in case of normal cyclic prefix depends on SCS configuration ρ.

If the Doppler frequency shift is compensated by shifting the carrier frequency, f₀ is replaced by f₀−f_{pre-comp} in Re{sₗ^{(p,μ)}(t)·e^{j2πf}^{₀}^{(t-t}^{_{start,l}}^{^{μ}}^{-N}^{_{CP,l}}^{^{μ}}^{T}^{_{c}}⁾} which becomes Re{sₗ^{(p,μ)}(t)·e^{j2π(f}^{₀}^{-f}^{_{pre-comp}}^{)(t-t}^{_{start,l}}^{^{μ}}^{-N}^{_{CP,l}}^{^{μ}}^{T}^{_{c}}⁾} for all channels and signals except PRACH, and f₀ is replaced by f₀−f_{pre-comp} in Re{sₗ^{(p,μ)}·e^{j2πf}^{₀}^{t}} which becomes Re{sₗ^{(p,μ)}·e^{j2π(f}^{₀}^{-f}^{_{pre-comp}}^{)t}} for PRACH. This destroys the constant phase across OFDM symbols at the receiver side (e.g., satellite) and hence will degrade demodulation performance.

To avoid this impact, frequency pre-compensation has to be applied without destroying the phase continuity of channel estimation across OFDM symbols. Since the frequency is the rate of change of the phase, in the present disclosure, compensation can be done with phase shift instead of frequency shift. To be more specific, phase shift means that f₀ is kept and a new phase term e^{-j2πf}^{_{pre-comp}} is added in Re{sₗ^{(p,μ)}(t)·e^{j2πf}^{₀}^{(t-t}^{_{start,l}}^{^{μ}}^{-N}^{_{CP,l}}^{^{μ}}^{T}^{_{c}}⁾} which becomes Re{sₗ^{(p,μ)}(t)·e^{j2πf}^{₀}^{(t-t}^{_{start,l}}^{^{μ}}^{-N}^{_{CP,l}}^{^{μ}}^{T}^{_{c}}⁾·e^{-j2πf}^{_{pre-comp}}^{t}} for all channels and signals except PRACH, and e^{-j2πf}^{_{pre-comp}} is added in Re{sₗ^{(p,μ)}(t)·e^{j2πf}^{_{pre-comp}}^{t}} for PRACH. Thus, the impact of frequency pre-compensation can be avoided.

It shall be noted that above phase shift pre-compensation can be applied to the downlink (DL) if DL pre-compensation is used by the NT network node 120 or the terrestrial network node 130.

Except for the Doppler frequency shift, delay drift on satellite links (e.g., service link and feeder link) may lead to signal distortion. To avoid signal distortion, delay drift compensation needs to be applied. Specifically, UE 110 may obtain the carrier frequency of the NTN and generate the upconversion signal by upconverting a baseband signal according to the carrier frequency. Additionally, UE 110 may obtain a time compression factor β of the NTN and calculate the time compression factor β as subtracting the delay drift from 1. In detail, the time compression factor β may be derived from a delay drift d which is the delay drift to be compensated in ppm. UE 110 may obtain the delay drift d of the NTN and calculate the time compression factor

$$β = \frac{1}{1 + d} .$$

Given that d is generally very small, the time compression factor β can be approximated to p=1−d.

Then, UE 110 may perform a timing compensation through applying the time compression factor β to the upconversion signal Re{sₗ^{(p,μ)}(t)·e^{j2πf}^{₀}^{(t-t}^{_{start,l}}^{^{μ}}^{-N}^{_{CP,l}}^{^{μ}}^{T}^{_{c}}⁾} for all channels and signals except PRACH, and Re{sₗ^{(p,μ)}·e^{j2πf}^{₀}^{t}} for PRACH.

In some implementations, UE 110 may perform the timing compensation through adjusting a sampling rate according to at least one of the time compression factor and the delay drift. For instance, if sampling of the signal is

$${F}_{s} = \frac{1}{{T}_{c}} ,$$

then applying the time compression factor β is equivalent to using T_{c}×β instead of T_{c}, hence the adjusted sampling rate

$${F}_{s \_ adjusted} = \frac{{F}_{s}}{{T}_{c} \times β} = \frac{( 1 + d ) {F}_{s}}{{T}_{c}} .$$

Fₛ denotes the sampling rate, τ_{c} denotes the time unit/sampling time for NR, and F_{s_adjusted} denotes the adjusted sampling rate.

In some implementations, the delay drift d corresponds to the service link delay drift dₛ on the service link between the NT network node 120 and the UE 110 due to one of a movement of the UE 110, a movement of the NT network node 120, and a combination thereof. The time compression factor β may be calculated as

$$β = \frac{1}{1 + {d}_{s}} ∼ 1 - {d}_{s} .$$

The service link delay drift dₛ may be signalled by the terrestrial network node 130 using one of an open loop, a closed loop, and a combination thereof. Alternatively, the service link delay drift dₛ may be calculated as the pre-compensation frequency value divided by the carrier frequency.

Alternatively, UE 110 may obtain its positions at various time via a Global Navigation Satellite System (GNSS) and calculate its velocity according to the positions. UE 110 may further obtain a position of the NT network node 120 and a velocity of the NT network node 120. Then, UE 110 may calculate the service link delay drift dₛ according to its positions, its velocity, and the position of the NT network node 120 and the velocity of the NT network node 120.

In some implementations, the delay drift d corresponds to a feeder link delay drift d_{f} on a feeder link between the NT network node 120 and the terrestrial network node 130 due to a movement of the NT network node 120. The time compression factor β may be calculated as

$$β = \frac{1}{1 + {d}_{f}} ∼ 1 - {d}_{f} .$$

The feeder link delay drift d_{f} may be signalled by the terrestrial network node 130 using one of an open loop, a closed loop, and a combination thereof. Alternatively, UE 110 may obtain a feeder link delay τ_{f}, a timing advance (TA), and a round trip time (RTT). The feeder link delay τ_{f} and the TA may be signalled to UE 110 by the terrestrial network node 130. Then, UE 110 may calculate the feeder link delay drift according to the feeder link delay, the TA, and the RTT.

Alternatively, UE 110 may obtain the position of the NT network node 120 and the velocity of the NT network node 120. Additionally, UE 110 may obtain a position of the terrestrial network node 130. Then, UE 110 may calculate the feeder link delay drift d_{f} according to the position of the NT network node 120, the velocity of the NT network node 120 and the position of the terrestrial network node 130.

In some implementations, the delay drift d corresponds to both of the service link delay drift dₛ and a feeder link delay drift d_{f} due to a movement of the NT network node 120 or both of the movement of the NT network node 120 and a movement of the UE 110. The time compression factor β may be calculated as

$$β = \frac{1}{( 1 + {d}_{s} ) ( 1 + {d}_{f} )} ∼ \frac{1}{1 + {d}_{s} + {d}_{f}} 1 - {d}_{s} - {d}_{f} .$$

It shall be noted that above timing compensation can be applied to the downlink (DL) if the delay drift to be compensated is used by the NT network node 120 or the terrestrial network node 130.

In some implementation, UE 110 may perform both of timing compensation and frequency compensation through applying the time compression factor β and the pre-compensation frequency value to the upconversion signal Re{sₗ^{(p,μ)})(β·t)·e^{j2πf}^{₀}^{(t-t}^{_{start,l}}^{^{μ}}^{-N}^{_{CP,l}}^{^{μ}}^{T}^{_{c}}⁾·e^{-j2πf}^{_{pre-comp}}^{t}} for all channels and signals except PRACH, and Re{sₗ^{(p,μ)}(β·t)·e^{j2πf}^{₀}^{t}·e^{-j2πf}^{_{pre-comp}}^{t}} for PRACH.

| Range of frequencies | SS block frequency position | | |
|---|---|---|---|
| (MHz) | SS_{REF} | GSCN | Range of GSCN |
| 0-3000 | N ^{×} 1200 kHz + M ⁺ 50 kHz, | 3N + (M − 3)/2 | 2-7498 |
| | N = 1:2499, M ϵ (1.3.5) (Note) | | |
| 3000-24250 | 3000 MHz + N ⁺ 1.44 MHz, | 7499 + N | 7499-22255 |
| | N = 0:14756 | | |
| 24250-100000 | 24250.08 MHz + N ⁺ | 22256 + N | 22256-26639 |
| | 17.28 MHz, | | |
| | N = 0:4383 | | |

(NOTE):
The default value for operating bands which only support SCS spaced channel raster(s) is M = 3.

The table above shows the global synchronization channel number (GSCN) parameters for the global frequency raster in 3GPP specification TS38.104 section 5.4.3 table 5.4.3.1-1. In this table, for frequencies smaller than 3 GHz, the synchronization raster has 100 kHz grid on the top of 1.2 MHz larger raster grid. This creates ambiguity in initial cell search and synchronization since the Doppler frequency shift and clock error may greater than 50 kHz.

Under a proposed scheme in accordance with the present disclosure, M can be restricted to a single value for NTN. For instance, M may be fixed to M=1, M=2 or M=3. Alternatively, M may be removed altogether from the definition of the synchronization raster.

The terrestrial network node 130 may indicate the synchronization raster information to UE 110 via master information block (MIB) or system information block (SIB). Once UE 110 knows it is on NTN carrier, it can then identify which synchronization raster it has detected and hence synchronize its clock accordingly.

### Illustrative Implementations

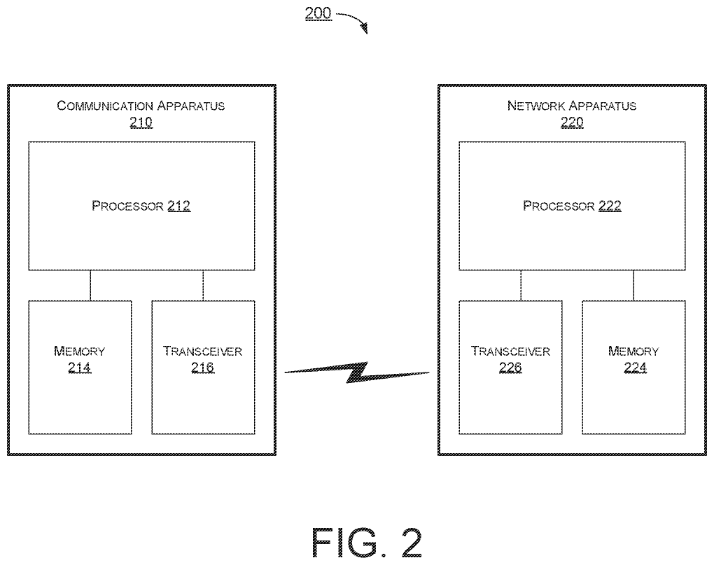

FIG. 2 illustrates an example communication system 200 having an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to carrier frequency, baseband signal, upconversion signal, pre-compensation frequency value, time compression factor for uplink frequency pre-compensation and timing compensation in NTN communications, including scenarios/schemes described above as well as processes 300 and 400 described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center.

Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNodeB in an LTE, in a gNB in a 5G, NR, 6G, IoT, NB-IoT, IIoT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., NT network node 120 or terrestrial network node 130) of a communication network (e.g., network 120). It is also noteworthy that, although the example implementations described below are provided in the context of NTN communications, the same may be implemented in other types of networks.

Under various proposed scheme in accordance with the present disclosure pertaining to carrier frequency, baseband signal, upconversion signal, and pre-compensation frequency value for uplink frequency pre-compensation in NTN communications, processor 212 of the communication apparatus 210 implemented in or as UE 110 may obtain a carrier frequency of non-terrestrial network (NTN). Processor 212 may generate an upconversion signal by upconverting a baseband signal according to the carrier frequency. Processor 212 may further obtain a pre-compensation frequency value via the transceiver 216. Processor 212 may perform UL frequency pre-compensation through adjusting a phase of the upconversion signal according to the pre-compensation frequency value.

Under various proposed scheme in accordance with the present disclosure pertaining to carrier frequency, upconversion signal, and time compression factor for timing compensation in NTN communications, processor 212 of the communication apparatus 210 implemented in or as UE 110 may obtain a carrier frequency of non-terrestrial network (NTN). Processor 212 may generate an upconversion signal by upconverting a baseband signal according to the carrier frequency. Furthermore, processor 212 may obtain a time compression factor of the NTN, and perform a timing compensation through applying the time compression factor to the upconversion signal.

### Illustrative Processes

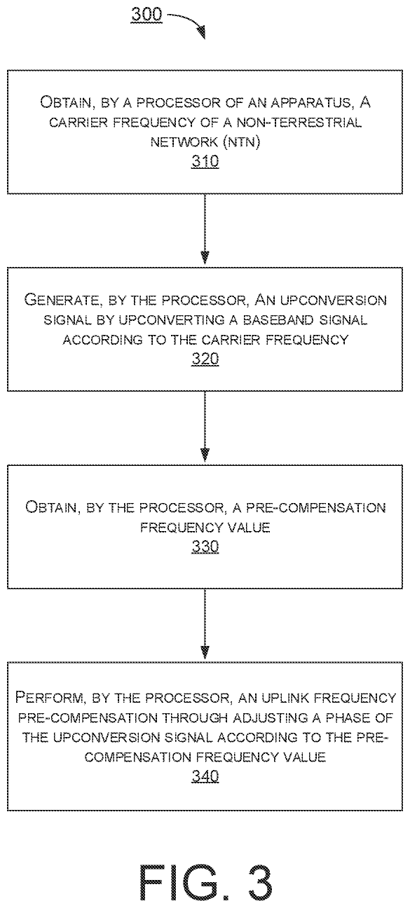

FIG. 3 illustrates an example process 300 in accordance with an implementation of the present disclosure. Process 300 may be an example implementation of schemes described above, whether partially or completely, with respect to the carrier frequency, baseband signal, upconversion signal, and pre-compensation frequency value for uplink frequency pre-compensation with the present disclosure. Process 300 may represent an aspect of implementation of features of communication apparatus 210. Process 300 may include one or more operations, actions, or functions as illustrated by one or more of blocks 310, 320, 330 and 340.

Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210.

Process 300 may begin at block 310. At block 310, process 300 may involve processor 212 of communication apparatus 210 obtaining a carrier frequency of non-terrestrial network (NTN). Process 300 may proceed from block 310 to block 320.

At block 320, process 300 may involve processor 212 generating an upconversion signal by upconverting a baseband signal according to the carrier frequency. Process 300 may proceed from block 320 to block 330.

At block 330, process 300 may involve processor 212 obtaining, via transceiver 216, a pre-compensation frequency value. Process 300 may proceed from block 330 to block 340.

At block 340, process 300 may involve processor 212 performing an uplink frequency pre-compensation through adjusting a phase of the upconversion signal according to the pre-compensation frequency value.

In some implementations, process 300 may involve processor 212 transmitting an uplink signal by applying the pre-compensation frequency value.

In some implementations, in obtaining the pre-compensation frequency value, process 300 may involve processor 212 performing certain operations. For instance, process 300 may involve processor obtaining a plurality of positions of the communication apparatus 210 via a Global Navigation Satellite System (GNSS) and calculate a velocity of the communication apparatus 210 according to the positions. Additionally, Process 300 may involve processor 212 obtaining a position and a velocity of a NT network node (e.g., the network apparatus 220) of the NTN. Process 300 may further involve processor 212 calculate the pre-compensation frequency value according to one of the positions of the apparatus, the velocity of the apparatus, the position of the NT network node and the velocity of the NT network node.

In some implementations, in obtaining the pre-compensation frequency value, process 300 may involve processor 212 performing certain operations. For instance, process 300 may involve processor 212 receiving the pre-compensation frequency value from the terrestrial network node using one of an open loop, a closed loop, and a combination thereof.

In some implementations, the pre-compensation frequency value corresponds to a Doppler frequency shift due to a movement of a non-terrestrial (NT) network node. Alternatively, the pre-compensation frequency value corresponds to the Doppler frequency shift due to a movement of the apparatus. Alternatively, the pre-compensation frequency value corresponds to the Doppler frequency shift due to the movement of the NT network node and the movement of the apparatus.

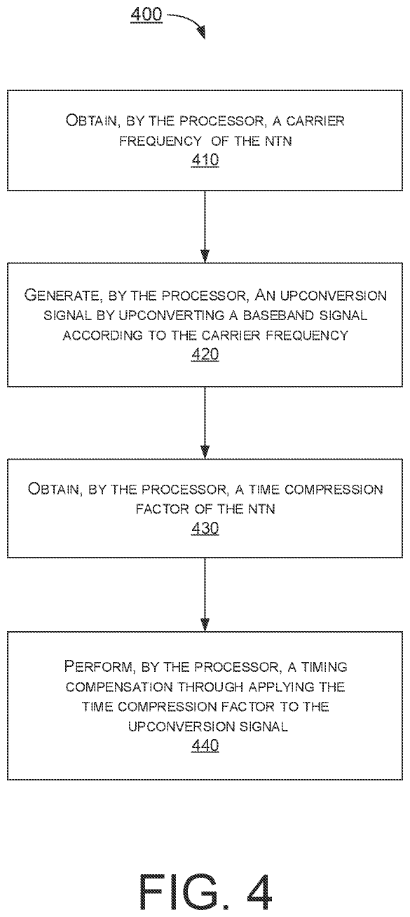

FIG. 4 illustrates an example process 400 in accordance with an implementation of the present disclosure. Process 400 may be an example implementation of schemes described above, whether partially or completely, with respect to the carrier frequency, upconversion signal, and time compression factor for timing compensation with the present disclosure. Process 400 may represent an aspect of implementation of features of communication apparatus 210. Process 400 may include one or more operations, actions, or functions as illustrated by one or more of blocks 410, 420, 430, and 440.

Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 210 or any suitable UE or machine type devices. Solely for illustrative purposes and without limitation, process 400 is described below in the context of communication apparatus 210.

Process 400 may begin at block 410. At block 410, process 400 may involve processor 212 of communication apparatus 210 obtaining a carrier frequency of the NTN. Process 400 may proceed from block 410 to block 420.

At block 420, process 400 may involve processor 212 generating an upconversion signal by upconverting a baseband signal according to the carrier frequency. Process 400 may proceed from block 420 to block 430.

At block 430, process 400 may involve processor 212 obtaining a time compression factor. Process 400 may proceed from block 430 to block 440.

At block 440, process 400 may involve processor 212 performing a timing compensation through applying the time compression factor to the upconversion signal.

In some implementations, in obtaining the time compression factor, process 400 may involve processor 212 performing certain operations. For instance, process 400 may involve the processor 212 obtaining a delay drift of the NTN. Process 400 may further involve processor 212 calculating the time compression factor as subtracting the delay drift from 1.

In some implementations, the delay drift corresponds to a service link delay drift on a service link between a non-terrestrial (NT) network node and the apparatus due to one of a movement of the apparatus, a movement of the NT network node, and a combination thereof.

In some implementations, in obtaining the service link delay drift, process 400 may involve processor 212 performing certain operations. For instance, process 400 may involve the processor 212 obtaining a plurality of positions of the apparatus via GNSS and calculating a velocity of the apparatus according to the positions. Process 400 may further involve processor 212 obtaining a position and a velocity of the NT network node. Process 400 may further involve processor 212 calculating the service link delay drift according to the positions of the apparatus, the velocity of the apparatus, and the position of the NT network node and the velocity of the NT network node.

In some implementations, the service link delay drift is signalled by a terrestrial network node using one of an open loop, a closed loop, and a combination thereof. Alternatively, the service link delay drift is calculated as the pre-compensation frequency value divided by the carrier frequency.

In some implementations, the delay drift corresponds to a feeder link delay drift on a feeder link between the NT network node and the terrestrial network node due to a movement of the NT network node.

In some implementations, in obtaining the service link delay drift, process 400 may involve processor 212 performing certain operations. For instance, process 400 may involve the processor 212 obtaining a position and a velocity of the NT network node. Process 400 may further involve processor 212 obtaining a position of the terrestrial network node. Process 400 may further involve processor 212 calculating the feeder link delay drift according to the position of the NT network node, the velocity of the NT network node and the position of the terrestrial network node.

In some implementations, in obtaining the service link delay drift, process 400 may involve processor 212 performing certain operations. For instance, process 400 may involve the processor 212 obtaining a feeder link delay, a timing advance (TA), and a round trip time (RTT). Process 400 may further involve processor 212 calculating the feeder link delay drift according to the feeder link delay, the TA, and the RTT.

In some implementations, the delay drift corresponds to the service link delay drift on the service link between the NT network node and the communication apparatus 210 and the feeder link delay drift on the feeder link between the NT network node and the terrestrial network node due to a movement of the NT network node or both of the movement of the NT network node and a movement of the communication apparatus 210.

In some implementations, in performing timing compensation, process 400 may involve processor 212 performing the timing compensation through adjusting a sampling rate according to at least one of the time compression factor and the delay drift.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
obtaining, by a processor of an apparatus, a carrier frequency of a non-terrestrial network (NTN);
generating, by the processor, an upconversion signal by upconverting a baseband signal according to the carrier frequency;
obtaining, by the processor, a pre-compensation frequency value; and
performing, by the processor, an uplink (UL) frequency pre-compensation through adjusting a phase of the upconversion signal according to the pre-compensation frequency value.

2. The method of claim 1, further comprising:
transmitting, by the processor, an uplink signal by applying the pre-compensation frequency value.

3. The method of claim 1, further comprising:
obtaining, by the processor, a plurality of positions of the apparatus via a Global Navigation Satellite System (GNSS);
calculating, by the processor, a velocity of the apparatus according to the positions;
obtaining, by the processor, a position of a non-terrestrial (NT) network node of the NTN;
obtaining, by the processor, a velocity of the NT network node; and
calculating, by the processor, the pre-compensation frequency value according to one of the positions of the apparatus, the velocity of the apparatus, the position of the NT network node and the velocity of the NT network node.

4. The method of claim 1, wherein the pre-compensation frequency value is signalled by a terrestrial network node using one of an open loop, a closed loop, and a combination thereof.

5. The method of claim 1, wherein the pre-compensation frequency value corresponds to a Doppler frequency shift due to a movement of a non-terrestrial (NT) network node.

6. The method of claim 19, wherein the pre-compensation frequency value corresponds to a Doppler frequency shift due to a movement of the apparatus.

7. The method of claim 1, wherein the pre-compensation frequency value corresponds to a Doppler frequency shift due to a movement of a non-terrestrial (NT) network node and a movement of the apparatus.

8. A method, comprising:
obtaining, by a processor of an apparatus, a carrier frequency of a non-terrestrial network (NTN);
generating, by the processor, an upconversion signal by upconverting a baseband signal according to the carrier frequency;
obtaining, by the processor, a time compression factor of the NTN; and
performing, by the processor, a timing compensation through applying the time compression factor to the upconversion signal.

9. The method of claim 8, further comprising:
obtaining, by the processor, a delay drift of the NTN; and
calculating, by the processor, the time compression factor as subtracting the delay drift from 1.

10. The method of claim 9, wherein the delay drift corresponds to a service link delay drift on a service link between a non-terrestrial (NT) network node and the apparatus due to one of a movement of the apparatus, a movement of the NT network node, and a combination thereof.

11. The method of claim 10, further comprising:
obtaining, by the processor, a plurality of positions of the apparatus via a Global Navigation Satellite System (GNSS);
calculating, by the processor, a velocity of the apparatus according to the positions;
obtaining, by the processor, a position of the NT network node;
obtaining, by the processor, a velocity of the NT network node; and
calculating, by the processor, the service link delay drift according to the positions of the apparatus, the velocity of the apparatus, the position of the NT network node and the velocity of the NT network node.

12. The method of claim 10, wherein the service link delay drift is signalled by a terrestrial network node using one of an open loop, a closed loop, and a combination thereof.

13. The method of claim 10, wherein the service link delay drift is calculated as the pre-compensation frequency value divided by the carrier frequency.

14. The method of claim 9, wherein the delay drift corresponds to a feeder link delay drift on a feeder link between a non-terrestrial (NT) network node and a terrestrial network node due to a movement of the NT network node.

15. The method of claim 14, further comprising:
obtaining, by the processor, a position of the NT network node;
obtaining, by the processor, a velocity of the NT network node;
obtaining, by the processor, a position of the terrestrial network node; and
calculating, by the processor, the feeder link delay drift according to the position of the NT network node, the velocity of the NT network node and the position of the terrestrial network node.

16. The method of claim 14, further comprising:
obtaining, by the processor, a feeder link delay;
obtaining, by the processor, a timing advance (TA);
obtaining, by the processor, a round trip time (RTT); and
calculating, by the processor, the feeder link delay drift according to the feeder link delay, the TA, and the RTT.

17. The method of claim 9, wherein the delay drift corresponds to a service link delay drift on a service link between a non-terrestrial (NT) network node and the apparatus and a feeder link delay drift on a feeder link between the NT network node and a terrestrial network node due to a movement of the NT network node or both of the movement of the NT network node and a movement of the apparatus.

18. The method of claim 9, further comprising:
performing, by the processor, the timing compensation through adjusting a sampling rate according to at least one of the time compression factor and the delay drift.

19. An apparatus, comprising:
a transceiver configured to wirelessly communicate with a non-terrestrial network (NTN); and
a processor coupled to the transceiver and configured to perform operations comprising:
obtaining a carrier frequency of a non-terrestrial network (NTN);
generating an upconversion signal by upconverting a baseband signal according to the carrier frequency;
obtaining, via the transceiver, a pre-compensation frequency value; and
performing an uplink (UL) frequency pre-compensation through adjusting a phase of the upconversion signal according to the pre-compensation frequency value.

20. The apparatus of claim 19, wherein the processor further performs operations comprising:
obtaining a time compression factor of the NTN; and
performing a timing compensation through applying the time compression factor to the upconversion signal.
